(19) United States
(12) Patent Application Publication
(10) Pub. No.: US 2024/0111254 A1
(43) Pub. Date: Apr. 4, 2024

(54) SYSTEM AND METHOD FOR WATCH SECURITY

(71) Applicant: Bret Thoeny, Los Angeles, CA (US)

(72) Inventor: Bret Thoeny, Los Angeles, CA (US)

(21) Appl. No.: 18/130,906

(22) Filed: Apr. 5, 2023

Related U.S. Application Data
(60) Provisional application No. 63/328,220, filed on Apr. 6, 2022.

(51) Int. Cl. G04G 21/02; G04G 21/04; G06K 19/077

(52) U.S. Cl. CPC G04G 21/02; G04G 21/04; G06K 19/07762

(57) ABSTRACT

A system and methods delegating incorporated technology to monitor, alert, and ensure the security of wrist watches. The approach comprises of various embodiments, such as modified spring bars with RFID and GPS tracking technologies, axial loaded barrels to reverberate notifications and signals in the event of watch disassembly, or a puck-like device that can relay personal data when connected to an external device. The device is therein altered with discrete technology that avoids compromising the allover look of a traditional mechanical watch. Security measures, which appear in the form of modified elements of the wristwatch, are covert and may be exercised with the use of an external device for connectivity, notifications, and tracking and monitoring.

### CROSS REFERENCE TO RELATED APPLICATIONS

This application claims the benefit of U.S. Provisional Patent Application Ser. No. 63/328,220, filed Apr. 6, 2022, the contents of which are incorporated herein by reference.

### BACKGROUND OF THE INVENTION

The present invention relates to a wearable device that contains an additional apparatus that enables Bluetooth pairing to mobile devices, and security tracking via RFID technology. The watch can therefore be transformed into a digitized variant while still maintaining the prestige of traditional mechanical watches. Mechanical watches utilize a clockwork mechanism in order to properly assess the passage of time. These watches are typically powered by a spring that can either be self-winding or wound by the use, a primary distinction from standard electromechanical watches that contain batteries or power sources that are in situ for the spring. Whereas analog to digital watch conversions require additional accessories that diminish the allover look and feel of a wristwatch; the present solution assures that neither component is sacrificed. While previous renditions have often placed RFID technology within watch faces, the present invention discloses other approaches that can trigger alarms upon disassembly of the band or lugs.

A spring bar, cylinder, lug, or spring actuated pins of the watch are therefore modified to discretely and securely monitor watch movements, as well as discharge alerts without the provision of an unwieldy attachment. With theft and burglary steadily increasing in the last few years, it is vital to safeguard belongings discretely. The marriage between a mechanical and a digital watch provide useful characteristics for the modern businessperson, who elects to merge style with both functionality and security.

### SUMMARY OF THE INVENTION

The present invention is a wearable device that contains an additional apparatus that enables Bluetooth pairing to mobile devices, and security tracking via RFID technology. The present invention functions with an added component to a standard mechanical watch. The primary motivation of a discrete and supplementary integrant is to modify and extend the watch's capabilities, in an attempt to avoid altering the general feel of wearing the watch, as well as the watch's design.

These units, such as a modified spring actuated pin, bar, trunnions, or other cylindrical article that is positioned between lugs. These components are equipped with features such as Bluetooth and GPS tracking through RFID technology and transceivers. The wristwatch comprises of a traditional circular and ring-shaped face, framed by lugs that may house the technology that digitizes a mechanical watch with the reassurance of added security. This remedies fears of obstruction of radio waves due to misplaced RFID tags, which upon exposure to inductive currents, may be susceptible to the degeneration of antennas. As a result, it is imperative to the design that the chip is shielded.

Digitized features are expelled through Bluetooth and RFID technology, which is incorporated into various aspects of the watch, and may be done by way of its lugs, spring bar or other cylindrical bar attachment, face, or the rearward of the face. These bars, framed by lugs, carry spring pressed studs or trunnions at each entry and end into apertures in the watch case's lugs. As watches vary in sizing, bars that do utilize springs may enable them to fit into different sizes of watch cases. Spring bars help provide more capacity and expansion in order to accommodate various wristwatch sizes, hence why it is essential to have both traditional spring bar mechanisms and alternatives.

Compact tag technology may be used to digitize the watch, thus making sending and receiving messages, alerts, emails, and other digital communications and elements possible with additional fixtures.

In one aspect, the watch contains a bezel that may display messages, which may appear on to an LED pixel display. In that same embodiment, the detachable patch can be positioned on to the back of the mechanical watch in order to transform it from wholly mechanical to a digitized variant, without sacrificing the traditional mechanical features of the watch's face. While smart watches typically only offer a wholly digital watch with mechanical faces, the present invention serves as a dynamic, detachable incorporation, offering both digital and mechanical faces that may operate individually. These patches can contain Bluetooth, RFID technology, or both.

In additional embodiments, a minuscule RFID chip is discreetly placed in a lug, spring bar, or groove of the watch. This aids in ensuring that this fixture cannot be easily removed without the consent of the wearer. The innovation may alert wearers how far their watch has moved, and other suspicious activity regarding their watch. In the unfortunate even that a watch is stolen, misplaced, seized or otherwise no longer on the wrist of its rightful owner, the RFID chip and additional technologies can send a string of alerts to any paired device showcasing the distance travelled, as well as the proximate or exact location of the watch. Regardless of how the watch is displaced, a user has the option to elect on how they wish to issue an alarm, and whether to notify nearby vendors based on the location of the watch. The watch may also embrace a physical alarm, which send out vibrations—an additional feature that may help those who might have misplaced their watch. An alarm may also be triggered upon disassembly of the watch, in order to prevent thieves from potentially removing the RFID chip. This can trigger when in a “finders' mode” or the like, in the event the watch has been conclusively stolen.

In the example of a lug, there could be detection features that have 2 or various number of lugs, and 1 lug on one axial spring-loaded barrel. While traditional axial spring-loaded barrels are made of aluminum, modified barrels, particularly utilizing crystal, could enable the reverberation of certain frequencies. These would be recognized by the axial spring and in turn, determine whether the wristwatch or bracelet has been loosened, tampered with, or even removed. This embodiment exists as a monitorization device, as well as an alert system for those who may try to bypass the invention's features through disassembly of the device.

It may also elect to send out alerts that can deter the watch from being sold to or distributed to third parties. Third party vendors may be able to analyze the watch's travels, ownership history, and whether the watch has been purloined based on the tracking tag data. This can be executed in two ways, either through an external device that has been connected to the invention's interface, or by scanning the body of the watch and assessing whether the device has been seized or stolen.

The present invention may also implement a pay per use agreement for the tracking service, which may be offered in partnership with distributors, or an insurance policy that is designated for the product itself. For spring bars and modified cylindrical attachments, Bluetooth technology may be situated in proximity to the RFID chip within the same cavity. A cavity within either tail end of the spring actuated pins or trunnions, or the base of the pin, may be used for insertion.

In one embodiment, a puck device may be attached rearward of the watch's face. Digital data can consequently be projected onto a rim that encircles the face. The presence of an additional Bluetooth component allows wearers to receive notifications including but not limited to messages, reminders, calendars, and alarms. The puck may be modified in order to alert as soon as disassembly has been attempted, and may employ the aforementioned aluminum alloy, crystal blend of materials in order to generate frequencies.

In another embodiment, the RFID tag is secured in a discrete manner beneath the watch's face and body, pressing against the top of a wearer's wrist. This can manifest in numerous shapes and sizes, in accommodation to the wearer. A thin film with RFID technology may be placed on the back of the watch that can report relevant information regarding the watch, such as where it was last seen, when it was last disassembled, and where the item is currently with an approximate geographic location, which can be translated into the desired unit of measurement (i.e., feet, miles, kilometers). This information can be accessed through various devices, such as a smart phone, or any other connectivity device.

In another alternative embodiment, the circuitry of the smart tag, smart link, or aforementioned RFID technology can be formulated in a puck like device that is to be associated with the body of the watch. That is, the invention can be attached to the body or bracelet of the watch itself, in the manifestation of a puck or external device attachment complimentary to lugs. Circuitry will involve a circuit that has the capacity to energize a coil, a tuned circuit, at a particular frequency. These circuits can have encryption elements, data, and a convertor and can assist in locking or securing components of the watch. This is executed by way of induction as a power source, which could charge a capacitator that may release or secure pins as desired. This can be applied to either a puck like device, a spring bar, or barrel.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIG. 1 is a depiction of an example wristwatch with the incorporated technology.

FIG. 2 is a more intimate overview of the rear end of the watch's face, and the disassembled spring bar with trunnions.

FIG. 3 is an overview of the spring bar, intact.

FIG. 4 is an internal overview of the spring bar's spring mechanism.

FIG. 5 is the modified spring with a cavity for an RFID chip.

FIG. 6 is an alternate display of the present invention, disclosing both threaded and screwed ends.

FIG. 7 is a schematic overview of the device's core processing unit, and radio frequency interface that are responsible for data and alerts.

### DETAILED DESCRIPTION OF THE PREFERRED EMBODIMENT

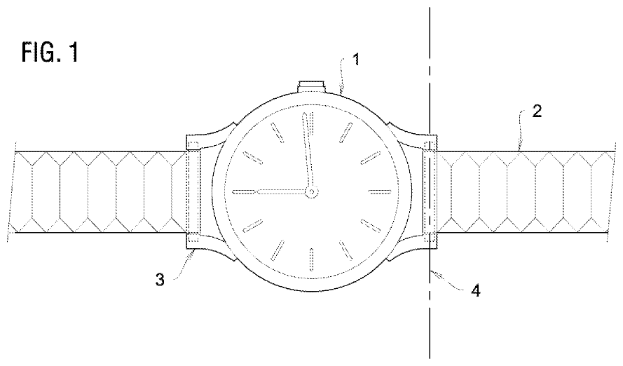

FIG. 1 features a typical watch 1 with the lugs 3 that house the RFID chip in the cavity of the spring bar or cylindrical article 4, which precedes the watch strap 2. The RFID chip or subsequent Bluetooth capabilities are positioned within a cavity of the spring bar.

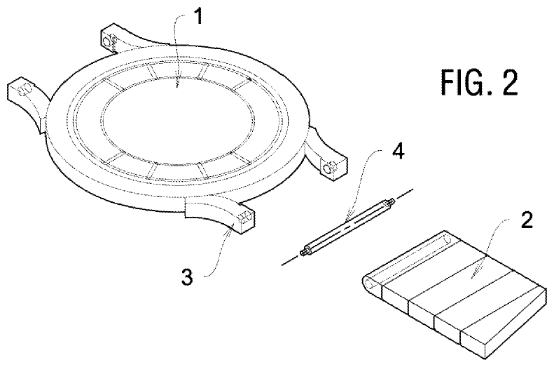

FIG. 2 is a back view of the watch 1, which may house a puck like device to digitize the watch, lugs 3 that are available for the insertion of the spring bar or cylindrical article 4, and the strap or links 2.

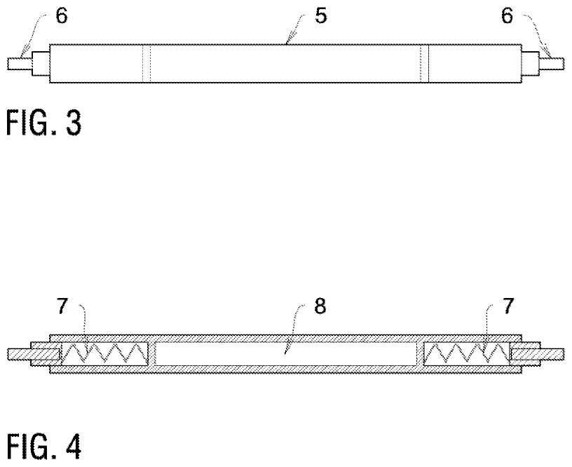

FIG. 3 is an overview of the spring bar 2, with its base being a traditional spring bar sleeve 5, and the bar's spring pin ends 6. The RFID chip is stationed within a cavern of the spring bar sleeve 5 and typically measure 12 to 23 millimeters in length.

FIG. 4 is an internal overview of the spring bar and the placement of the RFID chip. At the base of the spring bar sleeve 5 which upon modification, creates a cavity 8 that can discretely situate the RFID chip 8. This can be done without obstruction to the springs 7 for the bar.

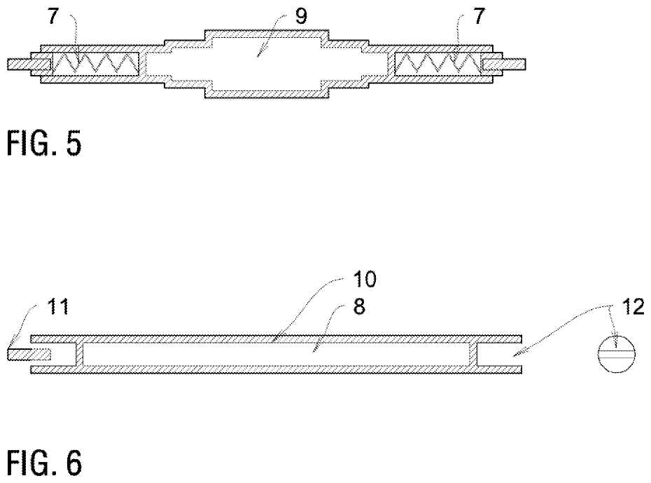

FIG. 5 showcases one iteration of the spring bar, which can be extended to create an even larger cavity for GPS transceiver 9. This is, yet again, done without obstructing the watch springs 7.

FIG. 6 depicts another manifestation of the bar with a threaded end 11 and a screw end 12 on opposite sides. In this example, there are no “springs”, just screws and a cavity for the RFID chip 9 or GPS transceivers 9.

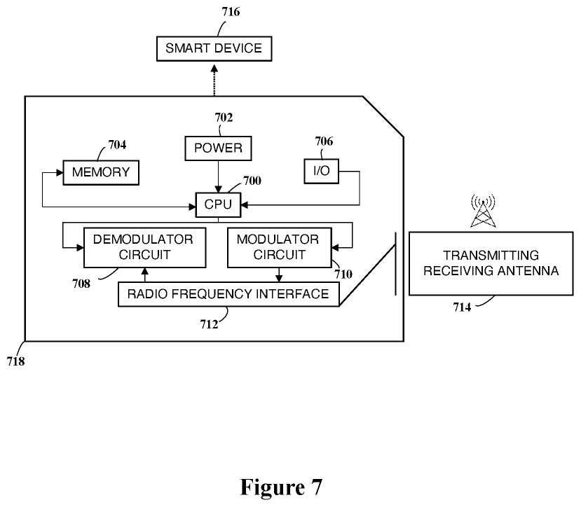

FIG. 7 depicts a schematic overview a central processing unit 700, in relation to the other elements that maintain smart communications. The central processing unit (CPU) 700 requires a power source 702. It has an area allocated to memory 704 and I/O capabilities 706 that enable the transmission of information 714 on to smart devices 716. The memory unit 704 carries data and information regarding the watch and supports Random Access Memory (RAM) and Read Only Memory (ROM). When signals are received on the transmitting receiving antenna 714 and the RFID tag 718. When query signals are caught, the CPU 700 enables the transmission of information regarding the watch that has been stored in its memory 704. Signals are exchanged through the demodulator 708 and modulator 710 circuits to and from radio frequencies. In another embodiment, the central processing unit 700 can manifest in different localities and embodiments of the watch, for example, a puck-like device that may be attached to the face of a watch, or a device that accommodates an axial loaded barrel that produces the necessary reverberations to alert, signal, and execute desired functions.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof, the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

What is claimed is:

1. A radio frequency identification chip embedded within a watch comprising:
a minuscule radio frequency identification chip stationed within a cavern of a watch spring bar;
a modified barrel to enable the reverberation of frequencies; and
a GPS transceiver, coupled with Bluetooth technology.

2. The embedded radio frequency identification chip apparatus of claim 1, wherein the chip is stationed inside of a watch lug.

3. The embedded radio frequency identification chip apparatus 1, wherein said chip is also coupled with said GPS transceiver that is located on the opposite end of a wristwatch.

4. The embedded radio frequency identification chip apparatus of claim 1, wherein said modified barrel is made of crystal to further enable the reverberation of frequencies.

5. The modified barrel in claim 4, wherein the modified barrel is said spring bar, cylinder, lug, or spring actuated pins that are modified to monitor watch movements and house said radio frequency identification chip.

6. The modified barrel in claim 4, wherein Bluetooth technology is situated in proximity to the radio frequency identification chip within the same cavity, or a cavity within either tail end of said spring actuated pins or trunnions, or the base of the pin, which enable insertion.

7. The modified barrel in claim 4, wherein the barrel features a spring bar mechanism to accommodate various wristwatch sizes and allow for insertion of said radio frequency identification chip.

8. A system for watch security, the system comprising:
a radio frequency identification chip embedded within a watch comprising:
a minuscule radio frequency identification chip stationed within a cavern of a watch spring bar;
a modified barrel to enable the reverberation of frequencies; and
a GPS transceiver, coupled with Bluetooth technology arranged in lug localities, embedded within an axial spring-loaded barrel made of crystal.

9. The global positioning system transceiver of claim 4, wherein said global positioning system can translate the location of a device into varying units of measurement, from feet to kilometers.

10. The embedded Bluetooth technology of claim 1, wherein said Bluetooth technology configured to a said connectivity device is a mobile phone or other connectivity device to gather tracking tag data on a wristwatch.

11. The global positioning system of claim 1, wherein said GPS system and said transceiver can report data such as when it was last seen, last disassembled, and its approximate geographic location.

12. The radio frequency identification chip embedded within said watch in claim 8, wherein said chip triggers an alarm upon an attempt to remove said chip, or an unauthorized disassembly of said watch.

13. The alarm in claim 12, wherein said alarm manifests as a vibration triggered by a lost alert authorized from a wearer of a watch.

14. The alarm in claim 12, wherein said alarm notifies local vendors of a lost watch to prevent local vendors from distributing or negotiating a stolen watch.

15. A method for watch security, the method comprising:
identifying the radio frequencies of an identification chip embedded within a watch;
stationing a minuscule radio frequency identification chip within a cavernous opening of a watch and spring bar;
modifying a barrel to enable the reverberation of frequencies by way of implementing an axial spring-loaded barrel;
receiving the GPS coordinates and exact location of a watch by way of a GPS transceiver coupled with Bluetooth technology that is arranged in various lug localities; and
embedding radio frequency identification chips within a watch in said various lug localities, including said axial spring-loaded barrel.

16. The method of claim 15, wherein said global positioning system translates the location of a device into varying units of measurement, from feet to kilometers.

17. The method of claim 15, wherein said Bluetooth technology configured to a said connectivity device is a mobile phone or other connectivity device to gather tracking tag data on a wristwatch.

18. The method of claim 15, wherein said GPS system and said transceiver can report data such as when it was last seen, last disassembled, and its approximate geographic location.

19. The method of claim 15, wherein said chip triggers an alarm upon an attempt to remove said chip, or an unauthorized disassembly of said watch, and wherein said alarm manifests as a vibration triggered by a lost alert authorized from a wearer of a watch.

20. The method of claim 19, wherein said alarm notifies local vendors of a lost watch to prevent local vendors from distributing or negotiating a stolen watch.
